(19) United States
(12) Patent Application Publication
(10) Pub. No.: US 2025/0296099 A1
(43) Pub. Date: Sep. 25, 2025

(54) Unmanned aerial vehicle (UAV)-based zonal spraying device and method for ecological restoration

(71) Applicant: Chengdu University Of Technology, Chengdu (CN)

(72) Inventors: Shenghua CUI, Chengdu (CN); Xiangjun PEI, Chengdu (CN); Qingwen YANG, Chengdu (CN); Yufang LIU, Chengdu (CN); Zhao WAN, Chengdu (CN); Yufeng WEI, Chengdu (CN); Tao JIANG, Chengdu (CN); Mengjie YANG, Chengdu (CN)

(73) Assignee: Chengdu University Of Technology, Chengdu (CN)

(21) Appl. No.: 18/784,993

(22) Filed: Jul. 26, 2024

(30) Foreign Application Priority Data
Mar. 25, 2024 (CN) 2024103440064

(51) Int. Cl. B05B 3/18; B64U 20/87; B64U 101/45

(52) U.S. Cl. CPC B05B 3/18; B64U 20/87; B64U 2101/45

(57) ABSTRACT

An unmanned aerial vehicle (UAV)-based zonal spraying device and method for ecological restoration is provided. The UAV-based zonal spraying device for ecological restoration includes a UAV body. Bottom ends of two sides of the UAV body are respectively provided with support legs. The UAV body includes a scanning mechanism, a spraying mechanism, and a nozzle mechanism. The spraying device can identify geological characteristics, acquire ecological geological environment data, determine different restoration zones according to terrain characteristics, select different treatment approaches, and load different slurries to achieve zonal ecological restoration for different types of geological disasters. In this way, the UAV-based zonal spraying device and method greatly improves the treatment efficiency and effectiveness for disaster recovery.

### CROSS REFERENCE TO THE RELATED APPLICATIONS

This application is based upon and claims priority to Chinese Patent Application No. 202410344006. 4, filed on Mar. 25, 2024, the entire contents of which are incorporated herein by reference.

### TECHNICAL FIELD

The present disclosure belongs to the technical field of restoration after a geological disaster, and in particular relates to an unmanned aerial vehicle (UAV)-based zonal spraying device and method for ecological restoration.

### BACKGROUND

In China, frequent geological disasters, including surface soil erosion, landslides, collapses, and other natural disasters, have caused huge losses to people's lives and property, and also seriously threaten the implementation of major national strategies and the construction of ecological civilization. With overall significance, this issue is related to China's ecological civilization construction. To solve this issue, it is necessary to achieve ecological restoration in geological disaster areas on the basis of eliminating potential geological disasters.

At present, it is difficult to carry out disaster recovery projects in remote areas. To solve the problem of difficulty for construction personnel to reach and high risk factors after geological disasters occur in remote areas, scientific and efficient treatment methods are still needed.

### SUMMARY

In response to the above-mentioned shortcomings in the prior art, the present disclosure provides a UAV-based zonal spraying device and method for ecological restoration, which solves the problems in remote areas such as high difficulty in implementing ecological restoration projects, difficulty for construction personnel to reach, and high risk factors.

To achieve the above objective, the present disclosure adopts the following technical solutions. The UAV-based zonal spraying device for ecological restoration includes a UAV body, where bottom ends of two sides of the UAV body are respectively provided with support legs; the UAV body includes a scanning mechanism and a spraying mechanism; the spraying mechanism is located at a middle position between the support legs, and includes spraying box; a partition is provided inside the spraying box; a water storage chamber is provided above the partition, and a rotating drive box is provided below the partition; a rotating drive assembly and a rotating pipe are provided inside the rotating drive box; the rotating pipe is connected to the rotating drive assembly, and a bottom end of the rotating pipe extends out of the rotating drive box and is connected to a nozzle mechanism; and the scanning mechanism is located on the nozzle mechanism, and the scanning mechanism includes a plurality of sensor assemblies.

The above-mentioned technical solution has the following beneficial effects. The scanning mechanism of the UAV can identify the lithology of the geological disaster area, delineate the landslide range, and analyze the vegetation growth trend in the disaster area. The scanning mechanism formed by a plurality of sensor assemblies can scan the geological disaster area, and determine the type of the geological disaster based on the scanning result. In this way, the UAV-based zonal spraying device for ecological restoration can carry out targeted spraying for different zones, effectively improving treatment efficiency and effectiveness.

After the restoration zone and the treatment approach are determined, the UAV flies back to the departure point to load the required restoration slurry. The restoration slurry can be stored in the water storage chamber inside the spraying box temporarily. The nozzle mechanism directly sprays the restoration slurry towards the restoration zone. Alternatively, the rotating drive assembly drives the nozzle mechanism to rotate and spray the restoration slurry, allowing a wide spraying range for the nozzle mechanism under a centrifugal force, thereby improving spraying efficiency. Through the scanning mechanism, the spraying mechanism, and the nozzle mechanism arranged on the UAV, the spraying device is suitable for disaster recovery operations in remote geological disaster areas, reducing the construction risk factor for construction personnel. The spraying device can also carry out different zonal restoration work according to different types of geological disasters, greatly improving the restoration efficiency and treatment effect, reducing the construction difficulty and risk factor of construction personnel.

Further, the sensor assemblies include a multispectral camera, a thermal infrared sensor, and a light detection and ranging (LiDAR) system.

The above-mentioned technical solution has the following beneficial effects. The multispectral camera can identify the lithology of the geological disaster area, delineate the landslide range, and analyze the vegetation growth trend in the disaster area. The thermal infrared sensor and the LiDAR system can acquire the terrain characteristic of the disaster area, construct the three-dimensional geological model of the disaster area, analyze the structural characteristic of the rock mass in the collapsed area, such as the parameter characteristic of a joint or a discontinuity, and a vegetation height. Through the cooperation of the multispectral camera, the thermal infrared sensor and the LiDAR, the spraying device can carry out zonal ecological restoration based on different types of geological disasters, effectively improving the treatment efficiency and effectiveness for disaster recovery.

Further, the rotating drive assembly includes a drive motor; the drive motor is located at a top of an inner wall of the rotating drive box, and an output end of the drive motor is provided with a driving gear; the driving gear meshes with a driven gear; and the driven gear is located outside the rotating pipe.

The above-mentioned technical solution has the following beneficial effects. When the drive motor rotates, the drive motor drives the driving gear to rotate. The driving gear drives the driven gear to rotate, and the driven gear drives the rotating pipe to rotate, thereby rotating the nozzle mechanism connected to the rotating pipe. The design expands the spraying range of the nozzle mechanism and improves the spraying efficiency.

Further, a lower end of the partition is provided with an electric push rod, and a telescopic section of the electric push rod is connected to the rotating drive box.

The above-mentioned technical solution has the following beneficial effects. During spraying, the electric push rod can extend the nozzle mechanism to a position below the support leg of the UAV, preventing the support leg from blocking the nozzle mechanism, thereby ensuring the spraying range and efficiency.

Further, a pumping assembly is provided inside the water storage chamber; the pumping assembly includes a high-pressure water pump and a flexible pipe connected to the high-pressure water pump; and the flexible pipe is connected to the rotating pipe through a pipe rotating joint.

The above-mentioned technical solution has the following beneficial effects. The water storage chamber can store the required slurry for spraying, and the high-pressure water pump can provide pressure during spraying, making it easy for the slurry to be sprayed out through flexible pipe and the rotating pipe. The design is suitable for spraying operations with low UAV flight altitude and low slurry volume.

Further, a side of the high-pressure water pump is provided with an external pumping pipe and an internal pumping pipe; the internal pumping pipe is located inside the water storage chamber; and the external pumping pipe extends out of the spraying box.

The above-mentioned technical solution has the following beneficial effects. The external pumping pipe can be connected to an external water source. When long-term spraying operations are required, water can be pumped and sprayed through the external pumping pipe connected to a long water pipe. When the spraying operation time is short, the slurry can be directly pumped and sprayed from the water storage chamber through the internal pumping pipe. Through the internal water pumping pipe and the external water pumping pipe of the water storage chamber, the spraying device can store water itself or connect an external water source, thereby improving the practicality of the spraying device.

Further, the external pumping pipe is provided with a first solenoid valve, and the internal pumping pipe is provided with a second solenoid valve.

The above-mentioned technical solution has the following beneficial effects. The first solenoid valve can control the opening and closing of the external pumping pipe, and the second solenoid valve can control the opening and closing of the internal pumping pipe, adapting to different spraying needs.

Further, the nozzle mechanism includes a conical nozzle or a circular nozzle.

The above-mentioned technical solution has the following beneficial effects. The conical nozzle is suitable for a low-concentration slurry for treating a rock slope collapse through a microbial membrane or a microbial induced calcite precipitation (MICP) technique or improving landslide stability through an ionic stabilizer. The circular nozzle is suitable for a high-concentration slurry for treating soil erosion through an ecological plant substrate or treating a landslide through a cement slurry. The spraying device offers different nozzles for different types of geological disasters, and can carry out direct or wide spraying for a specific area, improving the practicability of the spraying device.

The UAV-based zonal spraying method for ecological restoration is implemented by the UAV-based zonal spraying device for ecological restoration, and includes the following steps:
S1: starting a UAV, and allowing the UAV to fly over a geological disaster area; and acquiring, by the scanning mechanism, ecological geological environment data;
S2: identifying a type of a geological disaster by analyzing the data acquired by the scanning mechanism, adopting a zonal restoration mode, and determining a treatment approach;
S3: allowing, after a scan is completed, the UAV to fly back to a departure point to load a required slurry, and fly towards a designated zone according to a flight path; and
S4: opening the first solenoid valve or the second solenoid valve, and allowing the nozzle mechanism to spray the slurry to a target zone.

The above-mentioned technical solution has the following beneficial effects. In the present disclosure, through the spraying method, the spraying device can determine the type of the geological disaster and the zonal restoration mode based on the detected geological disaster situation, and adopt different spraying times, spraying amounts, and nozzle types according to actual spraying needs. The design effectively improves the spraying efficiency and practicality of the spraying device. In addition, the spraying device can select different treatment paths based on different types of geological disasters to achieve zonal ecological restoration, greatly improving the effectiveness of disaster treatment.

Overall, the UAV-based zonal spraying device and method for ecological restoration provided by the present disclosure have the following beneficial effects.
(1) In the present disclosure, the spraying device can identify the geological characteristic, acquire the ecological geological environment data, determine different restoration zones according to the terrain characteristic, select different treatment approaches and load different slurries to achieve zonal ecological restoration for different types of geological disasters, greatly improving the treatment efficiency and effectiveness for disaster recovery.
(2) In the present disclosure, the spraying mechanism can achieve rotational spraying, expanding the spraying range and improving the spraying efficiency under centrifugal force.
(3) In the present disclosure, the nozzle mechanism can select different spraying nozzles based on different types of geological disasters, and can achieve targeted or wide spraying, improving the spraying efficiency and practicality of the spraying device.
(4) In the present disclosure, the spraying device can choose to connect an external water source or store a slurry itself based on the spraying time or flight altitude during the spraying operation, thereby improving the applicability of the device.
(5) In the present disclosure, during spraying, the electric push rod can extend the nozzle mechanism to a position below the support leg of the UAV, preventing the support leg from blocking the nozzle mechanism, thereby ensuring the spraying range and efficiency.

### BRIEF DESCRIPTION OF THE DRAWINGS

FIG. 1 is a structural diagram of a UAV-based zonal spraying device for ecological restoration according to the present disclosure;

FIG. 2 is a structural diagram of the UAV-based zonal spraying device for ecological restoration in an operating state according to the present disclosure;

FIG. 3 is a structural diagram of a nozzle of the UAV-based zonal spraying device for ecological restoration according to the present disclosure; and

FIG. 4 is a structural diagram of a scanning mechanism of the UAV-based zonal spraying device for ecological restoration according to the present disclosure.

Reference Numerals: 1. UAV body; 2. support leg; 3. spraying mechanism; 31. spraying box; 32. partition; 33. water storage chamber; 34. rotating drive box; 35. rotating drive assembly; 351. drive motor; 352. driving gear; 353. driven gear; 36. rotating pipe; 37. electric push rod; 38. pumping assembly; 381. high-pressure water pump; 382. flexible pipe; 383. internal pumping pipe; 384. external pumping pipe; 385. first solenoid valve; 386. second solenoid valve; 387. pipe rotating joint; 4. nozzle mechanism; 41. conical nozzle; 42. circular nozzle; 5. scanning mechanism; 51. multispectral camera; 52. thermal infrared sensor; and 53. LiDAR system.

### DETAILED DESCRIPTION OF THE EMBODIMENTS

The specific embodiment of the present disclosure will be described below so that those skilled in the art can understand the present disclosure, but it should be clear that the present disclosure is not limited to the scope of the specific embodiment. For those of ordinary skill in the art, as long as various changes fall within the spirit and scope of the present disclosure defined and determined by the appended claims, these changes are apparent, and all inventions and creations using the concept of the present disclosure are protected.

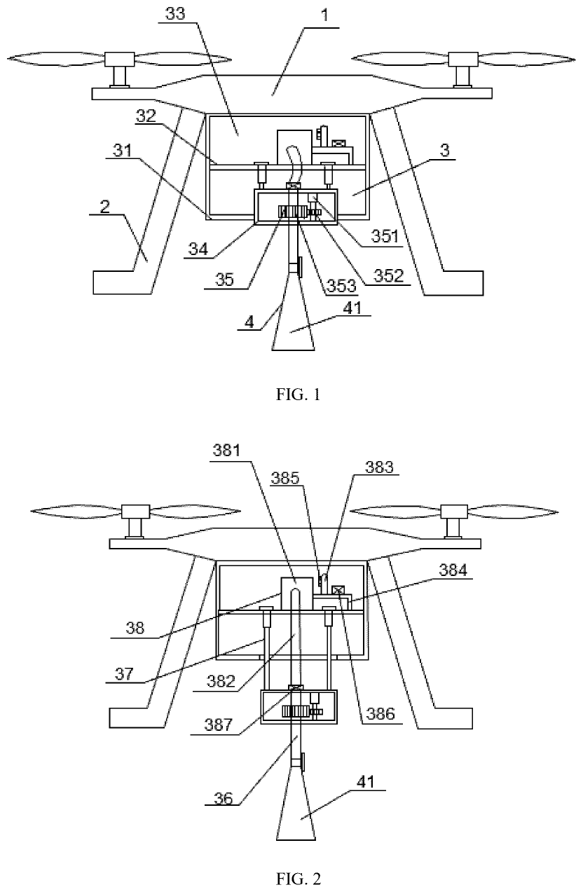

As shown in FIG. 1, the present disclosure provides a UAV-based zonal spraying device for ecological restoration, including UAV body 1. Bottom ends of two sides of the UAV body 1 are respectively provided with support legs 2, and the UAV body 1 includes scanning mechanism 5 and spraying mechanism 3.

During an implementation, through the scanning mechanism 5, the spraying device can identify the lithology of the geological disaster area, delineate the landslide range, and analyze the vegetation growth trend in the disaster area. The spraying device can also derive terrain characteristics of the disaster area, construct a three-dimensional geological model of the disaster area, and accurately acquire the ecological geological environment data of the geological disaster area. The spraying device can evaluate the suitability of ecological restoration based on identified parameters such as lithology, accumulation characteristics, crack size, and vegetation growth characteristics, identify the disaster type, analyze soil erosion and structural characteristics in the disaster area, identify geological environmental damage, and determine whether spraying operations are necessary. Meanwhile, the spraying device can adopt different restoration modes and determine different treatment paths based on different types of geological disasters. After the spraying device flies back to a departure point, the spraying mechanism 3 can load a required restoration slurry based on the scanning analysis results of the scanning mechanism 5, and directly spray or widely spray the restoration slurry towards the restoration zone from nozzle mechanism 4. Through the scanning mechanism 5, the spraying mechanism 3, and the nozzle mechanism 4 arranged on the UAV, the spraying device is suitable for disaster recovery operations in remote geological disaster areas, reducing the construction risk factor for construction personnel. The spraying device can also carry out different zonal restoration work according to different types of geological disasters, greatly improving the restoration efficiency and treatment effect, reducing the construction difficulty and risk factor of construction personnel.

In the present disclosure, the scanning mechanism 5 is located on the nozzle mechanism 4, and the nozzle mechanism 4 is replaceable. As shown in FIG. 4, the scanning mechanism 5 includes a plurality of sensor assemblies. The sensor assemblies include multispectral camera 51, thermal infrared sensor 52, and light detection and ranging (LiDAR) system 53. The multispectral camera 51 is configured to identify lithology in a geological disaster area, delineate a landslide range, and analyze a vegetation growth trend in the disaster area. The thermal infrared sensor 52 and the LiDAR system 53 are configured to acquire a terrain characteristic of the disaster area, construct a three-dimensional geological model of the disaster area, analyze a structural characteristic of a rock mass in a collapsed area, such as a parameter characteristic of a joint or a discontinuity, and a vegetation height. During an implementation, the scanning mechanism 5 formed by a plurality of sensors is configured to scan a geological disaster area, and determine a geological disaster type based on identified parameters such as lithology, accumulation characteristic, crack size, and vegetation growth characteristic. In this way, the UAV-based zonal spraying device for ecological restoration can carry out targeted spraying for different zones, effectively improving treatment efficiency and effectiveness.

As shown in FIG. 1, the spraying mechanism 3 is located at a middle position between the support legs 2, and includes a spraying box 31. Partition 32 is provided inside the spraying box 31. Water storage chamber 33 is provided above the partition 32, and rotating drive box 34 is provided below the partition 32. Rotating drive assembly 35 and rotating pipe 36 are provided inside the rotating drive box 34. The rotating pipe 36 is connected to the rotating drive assembly 35, and a bottom end of the rotating pipe 36 extends out of the rotating drive box 34 and is connected to the nozzle mechanism 4. During an implementation, the water storage chamber 33 inside the spraying box 31 is configured to store the restoration slurry. The nozzle mechanism 4 is configured to directly spray the restoration slurry towards the restoration zone. Alternatively, the rotating drive assembly 35 is configured to drive the nozzle mechanism 4 to rotate and spray the restoration slurry, allowing a wide spraying range for the nozzle mechanism 4 under a centrifugal force, thereby improving spraying efficiency.

As shown in FIGS. 1 and 2, the rotating drive assembly 35 includes drive motor 351. The drive motor 351 is located at a top of an inner wall of the rotating drive box 34, and an output end of the drive motor 351 is provided with driving gear 352. The driving gear 352 meshes with driven gear 353. The driven gear 353 is located outside the rotating pipe 36. When the drive motor 351 rotates, the drive motor 351 drives the driving gear 352 to rotate. The driving gear 352 drives the driven gear 353 to rotate, and the driven gear 353 drives the rotating pipe 36 to rotate, thereby rotating the nozzle mechanism 4 connected to the rotating pipe 36. The design expands the spraying range of the nozzle mechanism 4 and improves the spraying efficiency.

In the present disclosure, as shown in FIG. 2, a lower end of the partition 32 is provided with electric push rod 37. A telescopic section of the electric push rod 37 is connected to the rotating drive box 34. During spraying, the electric push rod 37 can extend the nozzle mechanism 4 to a position below the support leg 2 of the UAV, preventing the support leg 2 from blocking the nozzle mechanism 4, thereby ensuring the spraying range and efficiency.

As shown in FIG. 2, one side of the water storage chamber 33 is provided with a water inlet, and pumping assembly 38 is provided inside the water storage chamber. The pumping assembly 38 includes high-pressure water pump 381 and flexible pipe 382 connected to the high-pressure water pump 381. The flexible pipe 382 is connected to the rotating pipe 36 through pipe rotating joint 387. A side of the high-pressure water pump 381 is provided with external pumping pipe 384 and internal pumping pipe 383. The internal pumping pipe 383 is located inside the water storage chamber 33, and the external pumping pipe 384 extends out of the spraying box 31. The external pumping pipe 384 is provided with first solenoid valve 385, and the internal pumping pipe 383 is provided with second solenoid valve 386.

The first solenoid valve 385 is configured to control the opening and closing of the external pumping pipe 384, and the second solenoid valve 386 is configured to control the opening and closing of the internal pumping pipe 383. When the spraying device performs spraying operations, the high-pressure water pump 381 provides a pressure of 0-30 Mpa. When the flight altitude of the UAV is less than 50 m or when there is a large amount of slurry and it needs to be sprayed for a long time, the external pumping pipe 384 can be connected to a vehicle-mounted water source or a storage tank. When the flight altitude is greater than 50 m or the spraying time is short, the UAV needs to carry the required slurry itself, that is, the slurry is stored in the water storage chamber 33. Through the internal water pumping pipe 383 and the external water pumping pipe 384 of the water storage chamber 33, the spraying device can store water itself or connect an external water source, thereby improving the practicality of the spraying device.

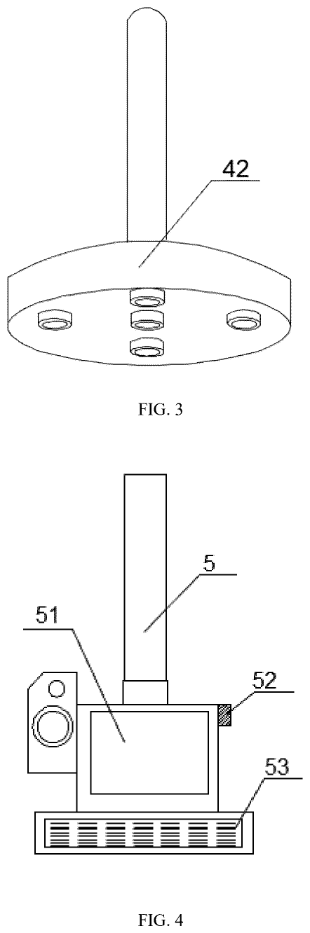

As shown in FIGS. 1, 2, and 3, in the present disclosure, the nozzle mechanism 4 includes conical nozzle 41 or circular nozzle 42. The conical nozzle 41 is suitable for a low-concentration slurry for treating a rock slope collapse through a microbial membrane or a microbial induced calcite precipitation (MICP) technique or improving landslide stability through an ionic stabilizer. The circular nozzle 42 is suitable for a high-concentration slurry for treating soil erosion through an ecological plant substrate or treating a landslide through a cement slurry. The spraying device offers different nozzles for different types of geological disasters, and can carry out direct or wide spraying for a specific area, improving the practicability of the spraying device.

A UAV-based zonal spraying method for ecological restoration is implemented by the UAV-based zonal spraying device for ecological restoration, and includes the following steps.
S1. The UAV is started to fly over a geological disaster area, and ecological geological environment data is acquired by the scanning mechanism 5.
S2. A type of a geological disaster is identified by analyzing the data acquired by the scanning mechanism 5, a zonal restoration mode is adopted, and a treatment approach is determined.
S3. After the scan is completed, the UAV flies back to a departure point to load the required slurry and follows a flight path towards a designated zone.
S4. The first solenoid valve 385 or the second solenoid valve 386 is opened to spray the slurry to the target zone through the nozzle mechanism 4.

In summary, in the present disclosure, the UAV-based zonal spraying device and method for ecological restoration can identify and analyze the geological characteristic of the geological disaster area, acquire the ecological geological environment data, determine different restoration zones according to the terrain characteristic, select different treatment approaches and load different slurries to achieve zonal ecological restoration, greatly improving the effectiveness of disaster treatment.

What is claimed is:

1. An unmanned aerial vehicle (UAV)-based zonal spraying device for an ecological restoration, comprising a UAV body, wherein bottom ends of two sides of the UAV body are respectively provided with support legs; the UAV body comprises a scanning mechanism and a spraying mechanism; the spraying mechanism is located at a middle position between the support legs, and comprises a spraying box; a partition is provided inside the spraying box; a water storage chamber is provided above the partition, and a rotating drive box is provided below the partition; a rotating drive assembly and a rotating pipe are provided inside the rotating drive box; the rotating pipe is connected to the rotating drive assembly, and a bottom end of the rotating pipe extends out of the rotating drive box and is connected to a nozzle mechanism; and the scanning mechanism is located on the nozzle mechanism, and the scanning mechanism comprises a plurality of sensor assemblies.

2. The UAV-based zonal spraying device according to claim 1, wherein the plurality of sensor assemblies comprise a multispectral camera, a thermal infrared sensor, and a light detection and ranging (LiDAR) system.

3. The UAV-based zonal spraying device according to claim 1, wherein the rotating drive assembly comprises a drive motor; the drive motor is located at a top of an inner wall of the rotating drive box, and an output end of the drive motor is provided with a driving gear; the driving gear meshes with a driven gear; and the driven gear is located outside the rotating pipe.

4. The UAV-based zonal spraying device according to claim 1, wherein a lower end of the partition is provided with an electric push rod, and a telescopic section of the electric push rod is connected to the rotating drive box.

5. The UAV-based zonal spraying device according to claim 1, wherein a pumping assembly is provided inside the water storage chamber; the pumping assembly comprises a high-pressure water pump and a flexible pipe connected to the high-pressure water pump; and the flexible pipe is connected to the rotating pipe through a pipe rotating joint.

6. The UAV-based zonal spraying device according to claim 5, wherein a side of the high-pressure water pump is provided with an external pumping pipe and an internal pumping pipe; the internal pumping pipe is located inside the water storage chamber; and the external pumping pipe extends out of the spraying box.

7. The UAV-based zonal spraying device according to claim 6, wherein the external pumping pipe is provided with a first solenoid valve, and the internal pumping pipe is provided with a second solenoid valve.

8. The UAV-based zonal spraying device according to claim 1, wherein the nozzle mechanism comprises a conical nozzle or a circular nozzle.

9. A UAV-based zonal spraying method for an ecological restoration, implemented by the UAV-based zonal spraying device according to claim 1 and comprising the following steps:
S1: starting a UAV, and allowing the UAV to fly over a geological disaster area; and acquiring, by the scanning mechanism, ecological geological environment data;
S2: identifying a type of a geological disaster by analyzing the ecological geological environment data acquired by the scanning mechanism, adopting a zonal restoration mode, and determining a treatment approach;
S3: allowing, after a scan is completed, the UAV to fly back to a departure point to load a required slurry, and fly towards a designated zone according to a flight path; and
S4: opening a first solenoid valve or a second solenoid valve, and allowing the nozzle mechanism to spray the required slurry to the designated zone.

10. The UAV-based zonal spraying method according to claim 9, wherein in the UAV-based zonal spraying device, the plurality of sensor assemblies comprise a multispectral camera, a thermal infrared sensor, and an LiDAR system.

11. The UAV-based zonal spraying method according to claim 9, wherein in the UAV-based zonal spraying device, the rotating drive assembly comprises a drive motor; the drive motor is located at a top of an inner wall of the rotating drive box, and an output end of the drive motor is provided with a driving gear; the driving gear meshes with a driven gear; and the driven gear is located outside the rotating pipe.

12. The UAV-based zonal spraying method according to claim 9, wherein in the UAV-based zonal spraying device, a lower end of the partition is provided with an electric push rod, and a telescopic section of the electric push rod is connected to the rotating drive box.

13. The UAV-based zonal spraying method according to claim 9, wherein in the UAV-based zonal spraying device, a pumping assembly is provided inside the water storage chamber; the pumping assembly comprises a high-pressure water pump and a flexible pipe connected to the high-pressure water pump; and the flexible pipe is connected to the rotating pipe through a pipe rotating joint.

14. The UAV-based zonal spraying method according to claim 13, wherein in the UAV-based zonal spraying device, a side of the high-pressure water pump is provided with an external pumping pipe and an internal pumping pipe; the internal pumping pipe is located inside the water storage chamber; and the external pumping pipe extends out of the spraying box.

15. The UAV-based zonal spraying method according to claim 14, wherein in the UAV-based zonal spraying device, the external pumping pipe is provided with the first solenoid valve, and the internal pumping pipe is provided with the second solenoid valve.

16. The UAV-based zonal spraying method according to claim 9, wherein in the UAV-based zonal spraying device, the nozzle mechanism comprises a conical nozzle or a circular nozzle.
